(19) United States
(12) Patent Application Publication
(10) Pub. No.: US 2020/0031063 A1
(43) Pub. Date: Jan. 30, 2020

(54) Method for Producing a Shaped Part

(71) Applicants: ThyssenKrupp Steel Europe AG, Duisburg (DE); thyssenkrupp AG, Essen (DE)

(72) Inventors: Lothar Patberg, Moers (DE); Stefan Mayer, Schwerte (DE); Andreas Cott, Dusseldorf (DE); Dieter Kalemba, Velbert (DE); Sophie Reisewitz, Schwerte (DE); Christian Paul, Meissen (DE); Erik Hilfrich, Dusseldorf (DE)

(21) Appl. No.: 16/337,110

(22) PCT Filed: Sep. 26, 2017
(86) PCT No.: PCT/EP2017/074379

§ 371 Date: Mar. 27, 2019

(30) Foreign Application Priority Data
Sep. 29, 2016 (DE) 10 2016 118 437.3

(51) Int. Cl. B29C 70/46; B29C 43/18; B29C 43/52; B32B 15/14

(52) U.S. Cl. CPC B29C 70/46; B29C 43/18; B29K 2105/06; B32B 15/14; B29C 2043/189; B29C 43/52

(57) ABSTRACT

A method of producing a shaped part includes method steps of: providing a first component composed of a metallic material and at least one second component composed of a fiber-plastic composite system; forming a composite including the first component and at least the second component; heating the formed composite to a target temperature above a melting temperature or glass transition temperature of plastic in the fiber-plastic composite system: and forming the heated composite into the shaped part by use of a forming mold.

### STATE OF THE ART

The invention relates to a method of producing a shaped part, especially a shaped part having a first component composed of a metallic material and at least one second component composed of a fiber-plastic composite system.

As a result of rising legal limitations for CO₂ output from motor vehicles and limited raw materials, there is rising interest in minimizing weight of individual vehicle components. As well as high-strength steels and lightweight metals, for example aluminum and magnesium, fiber-reinforced plastics or fiber-plastic composites in particular, in which fibers are incorporated into thermoplastic matrix materials, for example, have attracted the attention of the automobile industry as a group of materials owing to their high weight-specific strength and stiffness. It has been found here that abrupt failure and low stiffness of the matrix materials of the fiber-composite plastics are disadvantageous. There is therefore a particular interest in shaped parts made from hybrid structures that also include metals as well as fiber-reinforced plastics.

In general, shaped parts in the form of a hybrid structure are already known, for example from document DE 10 2013 104 635 A1. Also known in the prior art are additionally those shaped parts that firstly have a first layer comprising a metallic material and secondly a second layer comprising a fiber-plastic composite. These shaped parts are known as semifinished products from the vehicle industry, for example, and, as a hybrid structural part, permit combination of the advantageous material properties of the metal and of the fiber-plastic composite, namely a minimum weight, for example a desired absorption of energy in the event of a crash and a comparatively high strength.

Owing to the different behavior in the forming operation, the prior art discloses methods of producing these shaped parts composed of metal and a fiber-plastic composite system in which the metal and the fiber-plastic composite system are first shaped and, after the forming step, combined in a joining process. One reason for this procedure is that the fibers or fiber systems within the plastic matrix structure typically break under the stresses of a forming process. However, the complex joining process distinctly extends any cycle time with which this hybrid structure in the form of a shaped part can be provided.

### DISCLOSURE OF THE INVENTION

It is an object of the present invention to provide a method in which the manufacturing of shaped parts from a first metallic component and a second component that comprises a fiber-plastic composite system is simplified and especially accelerated.

The object is achieved by the present invention via a method of producing a shaped part, having the following method steps:
providing a first component composed of a metallic material and at least one second component composed of a fiber-plastic composite system
forming a composite comprising the first component and at least the second component
heating the composite to a target temperature above a melting temperature or glass transition temperature of the plastic,
   wherein, in a forming step, the heated composite is formed to the shaped part by means of a forming mold.

Compared to the methods known from the prior art, the first component comprising the metallic material and the second component comprising the fiber-plastic composite system are formed together in a composite, i.e. as a hybrid structure. The first component is preferably in monolaminar form or in layer form composed of a metallic material. The second component may be in mono- or multilaminar or mono- or multilayer form composed of a fiber-composite plastic system. A composite is understood to mean that, in a first execution, the first component composed of a metallic material (sheet) and the second component composed of a fiber-plastic system, comprising a plastics matrix and fibers, especially fibers within the plastics matrix, have already been cohesively bonded to one another or, in a second execution, the first and second components have not yet been bonded to one another, where the first and second components can be bonded before or during the forming step. In the second execution, the fiber-plastic composite system may firstly be provided in the form of fibers within the plastics matrix (consolidated state) or, secondly, the plastics matrix and the fibers may be provided in the as yet unconsolidated or partly consolidated state. As a result, it is advantageously possible to dispense with a complex downstream process of joining the first and second components. This is enabled by the heating of the composite to a target temperature above a melting temperature or glass transition temperature of the plastic or of the plastics matrix. It is thus possible to ensure that the fibers can move in a sliding manner in the second component and can be correspondingly aligned in the forming operation, such that any probability of breaking of the fibers is reduced. More particularly, process parameters are selected here depending on the respective materials in the first and second components, on the forming mold and on the predetermined target shape of the shaped part manufactured such that hybrid forming is effected in such a way that draping of the fibers within the composite and temporary flow of the plastics matrix during the forming step is possible.

Preferably, the forming process is a thermoforming operation. Examples of other conceivable forming processes are roll profiling, bending and/or beveling. Preferably, the first component is a metallic layer, for example a steel layer or a layer of aluminum, magnesium or stainless steel. Conceivable materials for the plastics matrix are especially thermoplastics, for example a polyamide (PA), a polyethylene (PE), a polyamide/polyethylene (PAPE) composition, polyphenyl sulfide (PPS), polysulfone (PSU) or polypropylene (PP), and also thermoset, elastomers and thermoplastic elastomers. Working examples of the fibers in the second component are carbon fibers, glass fibers, natural fibers, aramid fibers, polymer fibers, metal fibers, ceramic fibers or mineral fibers. Also conceivable here is use in the form of short fibers, long fibers or of continuous fibers.

Advantageous configurations and developments of the invention can be inferred from the dependent claims and from the description with reference to the drawings.

In a further embodiment of the present invention, the fibers are present in the form of a fiber system in the fiber-plastic composite system. For example, the fibers as a fiber system are in the form of a mat, a weave or a scrim. For those fiber systems with which corresponding reinforcement can be achieved in the fiber system manufactured, the method is found to be particularly advantageous since such fiber systems are particularly susceptible to breaking under the stress of a conventional process of forming of the second component. The second component may be provided over the full area or in part in the composite. More particularly, it is also possible for two or more second components to be arranged alongside one another in the composite.

In a further embodiment of the present invention, the fibers or fiber system are draped within the heated composite by adjusting and mutually matching a forming speed and a forming temperature in the forming step. This advantageously further reduces any probability of the breaking of the fibers or the fiber system. At the same time, the forming speed and forming temperature are especially matched to the material selection in the second lamina. Preferably, the forming mold comprises a hold-down device and/or a ram, and the forces that act on the composite and emanate from the hold-down device and/or ram are correspondingly adjusted. In one embodiment, a pressing force is adjusted such that adhesion between the hold-down device and the first lamina is greater than the adhesion between the fiber and the plastic or the plastic matrix.

In a further embodiment of the present invention, the formed composite is cooled down in the forming mold. More particularly, the formed composite is cooled down to a temperature below the melting temperature or glass transition temperature. As soon as the plastics matrix or the plastic has cooled down, the fibers that have been turned over in the forming process and draped are fixed in their new position by the cured plastics matrix.

In a further embodiment of the present invention, the composite is cooled down under pressure in the forming mold.

In a further embodiment of the present invention, a third component in layer form, for example, composed of a fiber-free plastic is provided, wherein the third component is disposed between two first components, two second components and/or, the first component and the second component.

This third component differs from the second component especially in that the third component is fiber-free, i.e. in that it does not have any fibers, by contrast with the second lamina. It is conceivable here that a thermoplastic layer (preferably of PAPE) as a third component serves in an advantageous manner as a coupling layer between the first and second components. In addition, it is preferably the case that the first component and second component are joined in a sandwich design in the composite, it being conceivable either that the first component is arranged effectively as a core lamina or core layer between second components or that the second component as core lamina or core layer is disposed between two first components. In a further embodiment, the composite comprises just one single first component and one single second component. In principle, it is also conceivable that the composite has a multilaminar configuration, wherein the composite is formed by the stacking of multiple first components and second components, and optionally further components. In this case, the first and second components preferably alternate.

In a further embodiment of the present invention, the heating is implemented by means of a tunnel kiln, by means of induction, by means of infrared light and/or by contact. If the fiber matrix used is a material comprising PA6, the composite is heated, for example, to a target temperature above 220° C. The composite is preferably heated outside the forming mold. Moreover, it is conceivable that the composite is transported from the heating region to the forming mold by means of a grab or conveyor transport.

In a further embodiment of the present invention, in the forming of the composite, the first component is cohesively bonded to the second component and any third component. Preferably, the first and second components and any third component are bonded to one two-dimensionally.

In a further embodiment of the present invention, the first component is provided from an aluminum- or magnesium-containing material, wherein the first component and two second components are bonded in a sandwich design to give a composite, wherein the first component is disposed between the second components, wherein the composite is especially formed with an unheated forming mold. In this case, it has been found that, surprisingly, forming of this composite does not require any heated forming mold. Moreover, it is possible to dispense with mold lubrication. The consequence is that the forming process is further simplified, and it is possible to save energy and consumable materials, for example a mold lubricant.

In a further embodiment of the present invention, two first components and the second component are bonded in the sandwich design to form a composite, wherein, for the second component, a plastics matrix is provided from a thermoplastic and fibers, preferably of the carbon fiber type, wherein the two first components surrounding the second component are provided from a steel-containing material. Such a shaped part is especially suitable as a semifinished product in the manufacture of a vehicle.

In a further embodiment of the present invention, the forming mold is opened at a time after the cooling for removal of the shaped part.

Further details, features and advantages of the invention will be apparent from the drawings and from the description below of preferred embodiments with reference to the drawings. The drawings illustrate merely illustrative embodiments of the invention that do not restrict the scope of the invention.

### BRIEF DESCRIPTION OF THE FIGURES

FIG. 1 shows a schematic of a method of producing a shaped part in one of the illustrative embodiments of the present invention.

FIGS. 2a to 2d show various composites composed of a first component and a second component provided for the method of the present invention.

### EMBODIMENTS OF THE INVENTION

In the various figures, identical parts are always given the same reference numerals and are therefore generally each named or mentioned only once.

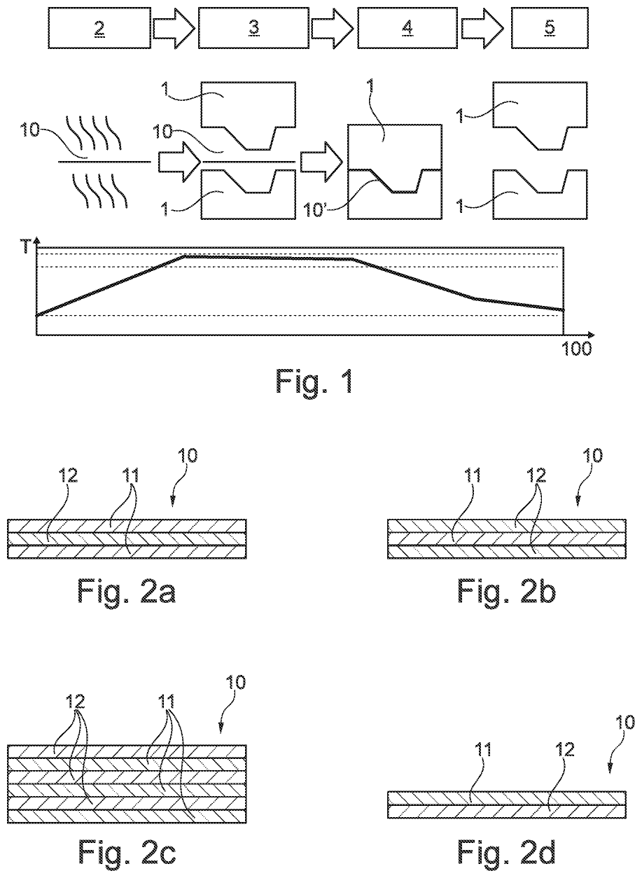

FIG. 1 shows a schematic of a method of producing a shaped part 10′. Such a shaped part 10′ constitutes, for example, a semifinished product which is installed in a later manufacturing step in a motor vehicle or in some other way, and is to be provided to this later manufacturing step in correspondingly preformed form. More particularly, the shaped part 10′ takes the form here of a hybrid composite or of a hybrid structure, wherein the shaped part firstly includes at least one first component in the form of a lamina 11 of a metallic material, for example steel, aluminum, magnesium or stainless steel, and secondly at least one second component in the form of a mono- or multilayer lamina 12 of a fiber-plastic composite system. In this case, the fiber-plastic composite system firstly comprises a plastics matrix, for example composed of a thermoplastic, such as PA, PE, PAPE, PP or the like, a thermoset, an elastomer or a thermoplastic elastomer, and secondly fibers within the plastics matrix, which are more preferably combined to form a fiber system within the plastics matrix (consolidated state). Conceivable fibers include carbon fibers, glass fibers, natural fibers, aramid fibers, polymer fibers, metal fibers, ceramic fibers or mineral fibers. In principle, short fibers or long fiber or continuous fiber reinforcements may be used. It is preferably the case that the fibers form a fiber system, for example in the form of a weave, a mat or a scrim. In order to shorten any cycle time in the production of the shaped part 10′, a composite 10 with at least one first component/lamina 11 and at least one second component/lamina 12 is provided, then the composite 10 formed is heated up and finally formed in a forming step 4, for example by a thermoforming process, by roll profiling, by bending, by beveling or the like, by means of a forming mold 1. As a result, it is advantageously possible to dispense with a joining process that otherwise follows the forming and in which the first component/lamina 11 is bonded in a complex manner to the second component/lamina 12. In order, however, to prevent destruction of the fiber-plastic composite system during the step 4 of forming the composite 10, the composite 10 formed, in the course of heating 2, is heated to a target temperature above a melting temperature or glass transition temperature of the plastics matrix, i.e. of a material from which the plastics matrix is manufactured. As a result, the fiber-plastic composite system is put in a state in which a viscosity of the plastics matrix that permits gliding movement of the fibers or of the fiber system within the plastics matrix is established. In addition, in particular, a forming speed, i.e. a speed with which forming of the composite is executed, and a forming temperature are matched inter alia to the movement of the fibers in the plastics matrix, such that the fibers or the fiber system can be turned over or draped during the forming step. In this case, the forming of multilayer systems comprising at least one first component in layer form composed of a metallic material and at least one second component in layer form composed of a fiber-plastic composite system and optionally at least one third component in layer form is possible, especially in sandwich form. Subsequently, the formed composite is cooled down in the forming mold 1. It is preferably the case here that a pressure acting on the composite 10 from the forming mold 1, preferably unheated forming mold 1, is maintained until the cooling process has ended. Finally, the forming mold 1 is opened for removal 5 of the shaped part. The lower part of FIG. 1 shows a temperature progression during the individual method steps. In this case, heating 2 of the composite 10 precedes insertion 3 of the composite 10 into the forming mold 1, and the cooling commences with the closing of the forming mold 1. As soon as a temperature at which the plastics matrix has cured is attained, the forming mold 1 can be opened again and the shaped composite can be removed from the forming mold 1.

FIGS. 2a to 2d show various composites composed of a first component in the form of a layer 11 and a second component in the form of a layer 12 for which the method according to the present invention is intended. In the particularly preferred variant shown in FIG. 2a, the second component/lamina 12 and two first components/laminas 11 are assembled in a sandwich design in which the second component/lamina 12 is disposed between the two first component/laminas 11, whereas, in FIG. 2b, the first component/lamina 11 and two second component/laminas 12 are assembled in the sandwich design in which the first component/lamina 11 is disposed between the two second components/laminas 12. More particularly, for the embodiment from FIG. 2a, the forming mold 1 is heated prior to the insertion of the composite 10, whereas it is conceivable in the embodiment from FIG. 2b that the composite 10 is effected in an unheated forming mold 1 when the first component/lamina 11 used is an aluminum- or magnesium-containing lamina. In the case of Al or Mg as outer lamina (top lamina), the forming mold is heated, in the case of Mg for example up to about 260° C. In the case of Mg or Al as inner lamina (core lamina), as is likewise the case with steel, irrespective of whether it is arranged internally or externally, a “cold” forming mold is used. In this case, it is also advantageously possible to dispense with mold lubrication. FIG. 2c shows an illustrative multilayer system in which any number of first components/laminas 11 and second components/laminas 12 are assembled to form the composite 10. More particularly, the composite 10 concludes on one side with the first component/lamina 11, and on another side opposite the side with the first component/lamina 11 with the second component/lamina 12. In addition, it is conceivable that, in the case of a composite 10 with multiple second components/laminas 12 composed of different fiber-plastic composite systems are used or, rather than a second component/lamina 12, a third component/lamina in the form of a plastics lamina, i.e. a fiber-free or non-fiber-reinforced plastics lamina, is disposed between two first components/laminas 11. Furthermore, it is also conceivable that the third component/lamina is disposed as a coupling layer between the first component/lamina 11 and the second component/lamina 12. In a further embodiment, the third lamina is disposed between two first components/laminas 11 in the composite. In addition, as a further variant, FIG. 2d shows a composite 10 composed of a single first component/lamina 11 and a single second component/lamina 12.

The invention is not restricted to the production of shaped parts for vehicle construction.

### LIST OF REFERENCE NUMERALS

1 forming mold
2 heating
3 insertion
4 forming step
5 removal
10 composite
10′ shaped part
11 first component/lamina
12 second component/lamina
100 time
T temperature

1. A method of producing a shaped part, comprising the steps of:
providing a first component comprising a metallic material and at least one second component comprising a fiber-plastic composite system;
forming a composite comprising the first component and at least the second component;
heating the formed composite to a target temperature above one of a melting temperature and a glass transition temperature of plastic in the fiber-plastic composite system; and,
forming the heated composite into the shaped part by use of a forming mold.

2. The method as claimed in claim 1, wherein fibers arc present in the form of a fiber system in the fiber-plastic composite system.

3. The method as claimed in claim 1, wherein the at least one second component is provided over one of a full area and in part in the composite.

4. The method as claimed in claim 2, wherein the fibers in the fiber system are draped within the healed composite by adjusting a forming speed and a forming temperature in the forming mold.

5. The method as claimed in claim 1, wherein the formed composite is cooled down in the forming mold.

6. The method as claimed in claim 4, wherein the formed composite is cooled down under pressure in the forming mold.

7. The method as claimed in claim 1, further comprising providing a third component comprised of a fiber-free plastic, wherein the third component is disposed between at least one of two first components, two second components, and the first component and the second component.

8. The method as claimed in claim 1, wherein the heating step is implemented by at least one of a tunnel kiln, induction, infrared light and contact.

9. The method as claimed in claim 1, wherein, in the forming of the composite, the first component is cohesively bonded to the second component.

10. The method as claimed in claim 1, wherein the first component is made of one of aluminum containing material and magnesium containing material, wherein the first component and two second components are bonded in a sandwiched design to form a sandwiched composite, wherein the first component is disposed between the two second components.

11. The method as claimed in claim 10, wherein the sandwiched composite is formed with an unhealed forming mold.

12. The method as claimed in claim 1, wherein two first components and the at least one second component are bonded in a sandwiched design to form a sandwiched composite, wherein, for the at least one second component, a plastics matrix is provided from a thermoplastic and carbon fibers, wherein the two first components surrounding the at least one second component are made of a steel-containing material.

13. The method as claimed in claim 1, wherein the forming mold is opened at a time after cooling for removal of the shaped part.

14. The method as claimed in claim 9, wherein, in the forming of the composite, the first component is cohesively bonded to the second component and to a third component.
